(19) United States
(12) Patent Application Publication
(10) Pub. No.: US 2025/0253565 A1
(43) Pub. Date: Aug. 7, 2025

(54) FLOATING-TYPE BOARD-TO-BOARD CONNECTOR ASSEMBLY AND FLOATING-TYPE PLUG CONNECTOR

(71) Applicant: ADVANCED-CONNECTEK INC., New Taipei City (TW)

(72) Inventors: Meng Liu, New Taipei City (TW); Ping Shi, New Taipei City (TW); Ta-Teh Meng, New Taipei City (TW)

(21) Appl. No.: 19/040,082

(22) Filed: Jan. 29, 2025

Related U.S. Application Data
(60) Provisional application No. 63/549,591, filed on Feb. 5, 2024.

(30) Foreign Application Priority Data
Dec. 23, 2024 (TW) 113214156

(51) Int. Cl. H01R 12/91; H01R 12/70

(52) U.S. Cl. CPC H01R 12/91; H01R 12/707

(57) ABSTRACT

A floating-type board-to-board connector assembly includes a plug connector and a receptacle connector. The plug connector includes a fixed base, a floating base, and plug terminals. Each plug terminal includes a flat contact portion, a flexible contact portion, and a soldering portion. For each plug terminal, the flexible connection portion is in an operation space of the fixed base, and two ends of the flexible connection portion respectively extend toward the flat contact portion and the soldering portion. The receptacle connector includes a base portion and receptacle terminals held in the base portion. For each receptacle terminal, a flexible contact portion is in an insertion portion of the base portion and adapted to contact the flat contact portion. The floating base is connected to the fixed base through the flexible connection portions of the plug terminals.

### CROSS-REFERENCE TO RELATED APPLICATIONS

This application claims the benefit of U.S. provisional application Ser. No. 63/549,591, filed on Feb. 5, 2024 and claims the priority of patent application No. 113214156 filed in Taiwan, R.O.C. on Dec. 23, 2024, the entire contents of which are hereby incorporated by reference.

### FIELD OF THE INVENTION

The instant disclosure relates to a floating-type board-to-board connector assembly and a floating-type plug connector.

### BACKGROUND

Board-to-board connectors are mainly provided to allow respective devices to establish an electrical connection therebetween using respective circuit boards, so that the electrical signals and the electricity can be transmitted and conducted.

Because a board-to-board receptacle connector and a board-to-board plug connector known to the inventor are respectively fixedly soldered on circuit boards, after the receptacle connector is mated with the plug connector, the positions of the connectors are also fixed, and accordingly such configuration leads some issues. For example, because the board-to-board receptacle connector and the board-to-board plug connector cannot be moved after the connector are mated with each other, when the connectors are applied for a circumstance in which wobbling occurs easily (for example, automotive electronics), the wobbling caused by the movement of the vehicle will lead the board-to-board receptacle connector and the board-to-board plug connector known to the inventor to be detached from each other or even broken, thereby causing poor signal transmission or even loss of signal.

### SUMMARY OF THE INVENTION

In view of these, one embodiment of the instant disclosure provides a floating-type board-to-board connector assembly. The floating-type board-to-board connector assembly comprises a plug connector and a receptacle connector. The plug connector comprises a fixed base, a floating base, and a plurality of plug terminals. The fixed base has an operation space, the floating base is in the operation space, and the floating base comprises a tongue portion. Each of the plug terminals comprises a flat contact portion, a flexible contact portion, and a soldering portion. For each of the plug terminals, the flexible connection portion is in the operation space of the fixed base, the flat contact portion extends from one of two ends of the flexible connection portion toward a surface of the tongue portion, and the soldering portion extends from the other end of the flexible connection portion and is exposed from the fixed base. The receptacle connector comprises a base portion and a plurality of receptacle terminals. The base portion comprises an insertion portion, and the insertion portion has a mating space adapted to be inserted by the tongue portion. Each of the receptacle terminals is held in the base portion, and each of the receptacle terminals comprises a flexible contact portion, an extension portion, and a soldering portion. For each of the receptacle terminals, the flexible contact portion is in the mating space and adapted to contact the flat contact portion, the extension portion is at a top surface of the base portion and bends along an outer side surface of the base portion, the flexible contact portion extends from one of two ends of the extension portion toward a lower opening of the base portion, and the soldering portion extends from the other end of the extension portion and protrudes from the outer side surface of the base portion. The floating base is connected to the fixed base through the flexible connection portions of the plug terminals, so that the flat contact portions of the plug terminals can be kept contacting the flexible contact portions of the receptacle terminals.

In some embodiments, the floating base has a first position along at least one axis, and the flexible connection portion of each of the plug terminals is adapted to provide a resilient force to retain the floating base at the first position.

In some embodiments, the at least one axis comprises a first axis and a second axis, and the floating base is movable along the first axis and has the first position and a second position. When the floating base is moved from the first position toward the second position, the floating base is moved close to the receptacle connector. The floating base is movable along the second axis and has the first position and a third position. When the floating base is moved from the first position toward the third position, the floating base is moved toward or away from one side of the fixed base.

In some embodiments, the fixed base of the plug connector has a through groove, and the through groove forms the operation space. The floating base further comprises a base plate, the base plate is in the through groove, and the flexible connection portion of each of the plug terminals is in a gap between the base plate and the fixed base. The tongue portion protrudes from the base portion, and a center line of the tongue portion is aligned with a central axial line of the base plate.

In some embodiments, for each of the plug terminals, the flat contact portion is in a terminal recess of the tongue portion, the flexible connection portion is engaged with the terminal recess and a terminal fixation groove of the through groove, and the soldering portion extends outwards along a bottom surface of the terminal fixation groove.

In some embodiments, the plug connector further comprises two plug pressing plates, and each of the plug pressing plates covers the base plate of the floating base and the fixed base.

In some embodiments, the base portion of the receptacle connector further comprises two abutting portions and two receptacle pressing plates. The abutting portions protrude from an outer side surface of the base portion, and the two receptacle pressing plates are respectively arranged at the two abutting portions. Each of the receptacle pressing plates has a soldering leg, and the soldering leg, the soldering portion of each of the receptacle terminals, and a bottom surface of each of the abutting portions are at a same horizontal plane.

In some embodiments, the base portion of the receptacle connector further comprises a plurality of terminal grooves and a plurality of terminal channels. The terminal grooves are between the abutting portions, and the soldering portion of each of the receptacle terminals protrudes from a corresponding one of the terminal grooves. Each of the terminal channels extends from the top surface of the base portion toward a bottom surface of the base portion, each of the terminal channels corresponds to a corresponding one of the terminal grooves, and the flexible contact portion of each of the receptacle terminals is in a corresponding one of the terminal channels.

In some embodiments, each of the terminal channels comprises a mating portion and a lower opening portion. The mating portions of two opposite terminal channels among the terminal channels are in communication with each other and have a mating opening to form the mating space. The lower opening portion has the lower opening, and the lower opening is at the bottom surface of the base portion and at one side of the mating opening.

In some embodiments, for each of the receptacle terminals, a distance between a top portion of the extension portion and the soldering portion is less than a distance between the top portion of the extension portion and a free end of the flexible contact portion.

Another embodiment of the instant disclosure provides a floating-type plug connector. The floating-type plug connector is adapted to be mated with a receptacle connector, and comprises a fixed base, a floating base, and a plurality of plug terminals. The fixed base has an operation space, the floating base is in the operation space, and the floating base comprises a tongue portion. Each of the plug terminals comprises a flat contact portion, a flexible contact portion, and a soldering portion. For each of the plug terminals, the flexible connection portion is in the operation space of the fixed base, the flat contact portion extends from one of two ends of the flexible connection portion toward a surface of the tongue portion, and the soldering portion extends from the other end of the flexible connection portion and is exposed from the fixed base. The floating base is connected to the fixed base through the flexible connection portions of the plug terminals.

In some embodiments, the floating base has a first position along at least one axis, and the flexible connection portion of each of the plug terminals is adapted to provide a resilient force to retain the floating base at the first position.

In some embodiments, the at least one axis comprises a first axis and a second axis, and the floating base is movable along the first axis and has the first position and a second position. When the floating base is moved from the first position toward the second position, the floating base is moved close to the receptacle connector. The floating base is movable along the second axis and has the first position and a third position. When the floating base is moved from the first position toward the third position, the floating base is moved toward or away from one side of the fixed base.

In some embodiments, the fixed base has a through groove, and the through groove forms the operation space. The floating base further comprises a base plate, the base plate is in the through groove, and the flexible connection portion of each of the plug terminals is in a gap between the base plate and the fixed base. The tongue portion protrudes from the base portion, and a center line of the tongue portion is aligned with a central axial line of the base plate.

In some embodiments, for each of the plug terminals, the flat contact portion is in a terminal recess of the tongue portion, the flexible connection portion is engaged with the terminal recess and a terminal fixation groove of the through groove, and the soldering portion extends outwards along a bottom surface of the terminal fixation groove.

In some embodiments, the floating-type plug connector further comprises two plug pressing plates, and each of the plug pressing plates covers the base plate of the floating base and the fixed base.

In some embodiments, the receptacle connector comprises a base portion and a plurality of receptacle terminals. The base portion comprises an insertion portion, and the insertion portion has a mating space adapted to be inserted by the tongue portion. Each of the receptacle terminals is held in the base portion, and each of the receptacle terminals comprises a flexible contact portion, an extension portion, and a soldering portion. For each of the receptacle terminals, the flexible contact portion is in the mating space and adapted to contact the flat contact portion, the extension portion is at a top surface of the base portion and bends along an outer side surface of the base portion, the flexible contact portion extends from one of two ends of the extension portion toward a lower opening of the base portion, and the soldering portion extends from the other end of the extension portion and protrudes from the outer side surface of the base portion. The base portion further comprises two abutting portions and two receptacle pressing plates. The abutting portions protrude from an outer side surface of the base portion, and the two receptacle pressing plates are respectively arranged at the two abutting portions. Each of the receptacle pressing plates has a soldering leg, and the soldering leg, the soldering portion of each of the receptacle terminals, and a bottom surface of each of the abutting portions are at a same horizontal plane.

In some embodiments, the base portion of the receptacle connector further comprises a plurality of terminal grooves and a plurality of terminal channels. The terminal grooves are between the abutting portions, and the soldering portion of each of the receptacle terminals protrudes from a corresponding one of the terminal grooves. Each of the terminal channels extends from the top surface of the base portion toward a bottom surface of the base portion, each of the terminal channels corresponds to a corresponding one of the terminal grooves, and the flexible contact portion of each of the receptacle terminals is in a corresponding one of the terminal channels.

In some embodiments, each of the terminal channels comprises a mating portion and a lower opening portion. The mating portions of two opposite terminal channels among the terminal channels are in communication with each other and have a mating opening to form the mating space. The lower opening portion has the lower opening, and the lower opening is at the bottom surface of the base portion and at one side of the mating opening.

In some embodiments, for each of the receptacle terminals, a distance between a top portion of the extension portion and the soldering portion is less than a distance between the top portion of the extension portion and a free end of the flexible contact portion.

According to some embodiments of the instant disclosure, because the receptacle connector and the plug connector are mated with each other in a floating manner.

Moreover, the floating base of the plug connector has movement tolerances along multiple axes in the operation space of the fixed base, so that the connector assembly can absorb the external force suffered during shaking. Moreover, such configuration ensures the stability of the floating base and allows the electrical connection between the receptacle connector and the plug connector to be maintained properly.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates an exploded view of a floating-type board-to-board connector assembly and circuit boards according to some embodiments of the instant disclosure, where the floating-type board-to-board connector assembly is assembled on the circuit boards;

FIG. 2 illustrates an exploded view of a floating-type board-to-board connector assembly according to some embodiments of the instant disclosure;

FIG. 3 illustrates an exploded view of a receptacle connector according to some embodiments of the instant disclosure;

FIG. 4 illustrates a cross-sectional view along the line 4-4 shown in FIG. 3;

FIG. 5 illustrates a cross-sectional view along the line 5-5 shown in FIG. 3;

FIG. 6 illustrates a perspective view of a receptacle terminal according to some embodiments of the instant disclosure;

FIG. 7 illustrates an exploded view of a plug connector according to some embodiments of the instant disclosure;

FIG. 8 illustrates a perspective view of a plug terminal according to some embodiments of the instant disclosure;

FIG. 9 illustrates a perspective view of a floating-type board-to-board connector assembly according to some embodiments of the instant disclosure, where the circuit boards are not shown;

FIG. 10 illustrates a cross-sectional view along the line 10-10 shown in FIG. 9;

FIG. 11 illustrates a cross-sectional view (1) along the line 11-11 shown in FIG. 9, where the circuit boards are illustrated with one dot-dashed lines, the floating base illustrated with solid lines indicates that the floating base is at the original position, and the floating base illustrated with dashed lines indicates that floating base is at the wobbling position; and

FIG. 12 illustrates a cross-sectional view (2) along the line 11-11 shown in FIG. 9; where the floating base is at the shaking position, and the circuit boards are illustrated with one dot-dashed lines.

### DETAILED DESCRIPTION

In the following embodiments, unless specifically described as electrical connections, the connections described may be physical connections or may refer to direct or indirect connections between physical components. Additionally, it should be noted that the drawings of the instant disclosure are for illustrative purposes only, not necessarily drawn to scale, and not all details may be presented in the drawings. Furthermore, terms such as “one,” “two,” “upper,” etc. used in instant disclosure are merely for clarity of description and not intended to limit the scope of implementation of the instant disclosure. Changes or adjustments in relative relationships of the components, without substantially changing the technical content, should also be considered within the scope of implementation of the instant disclosure.

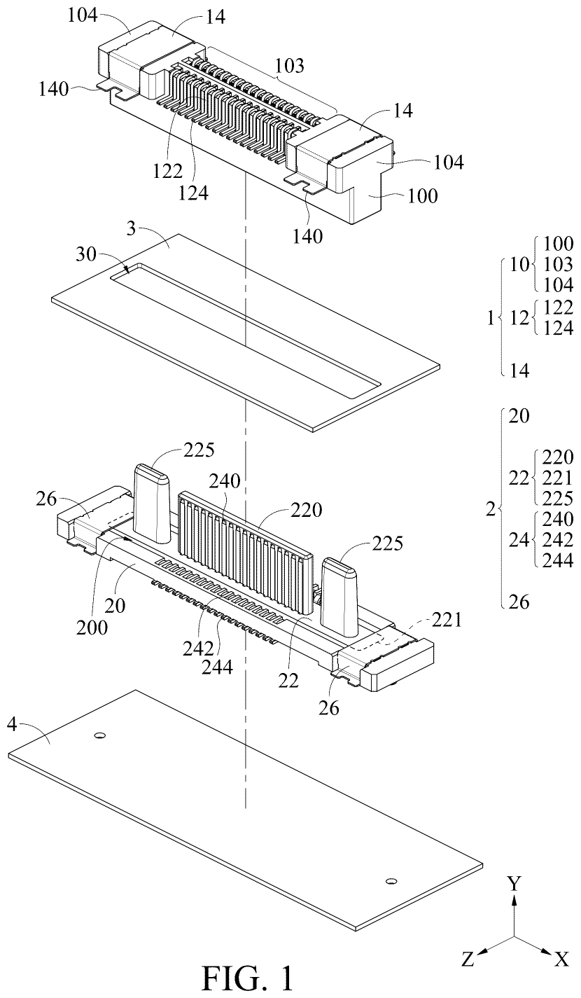

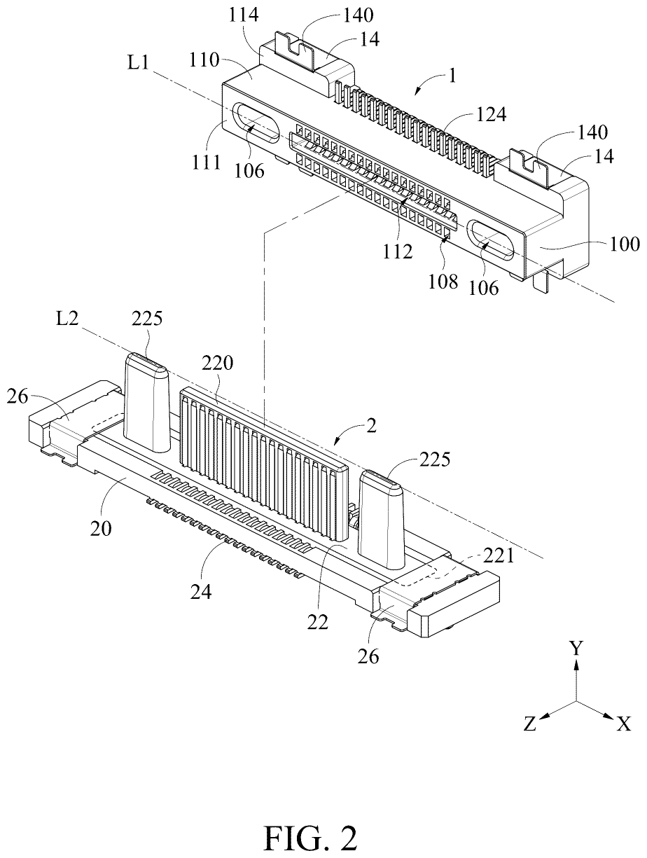

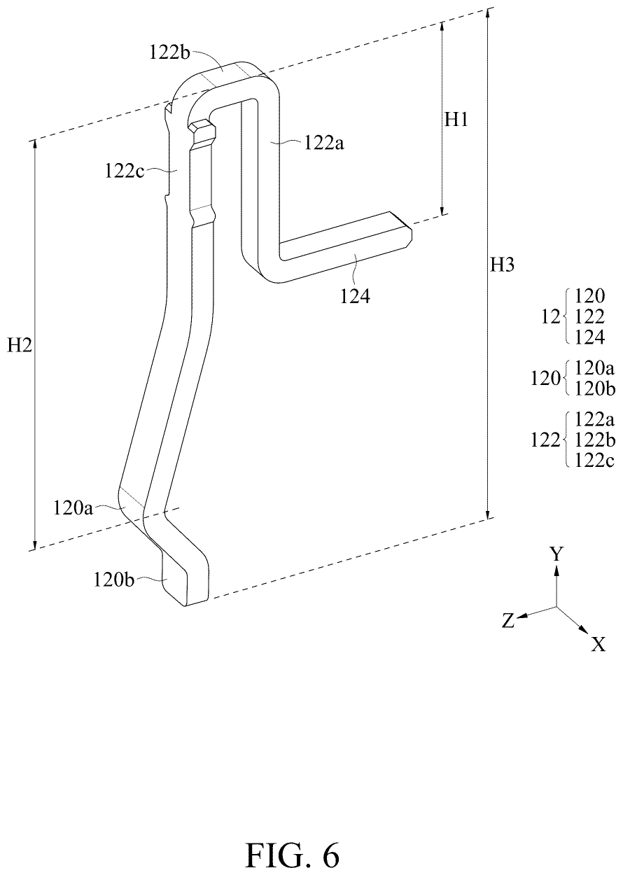

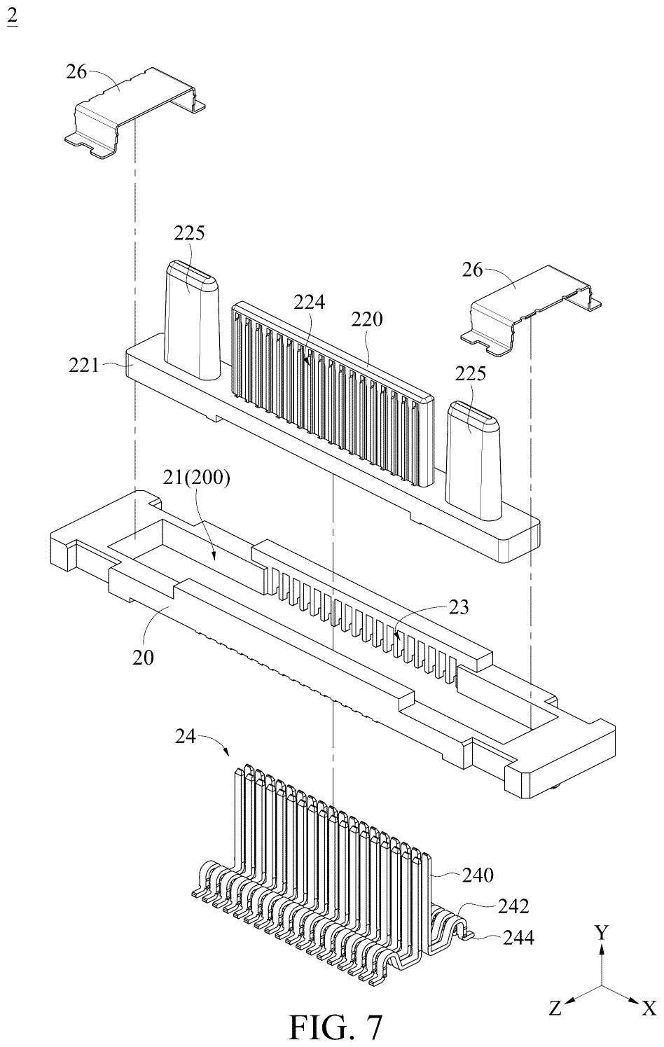

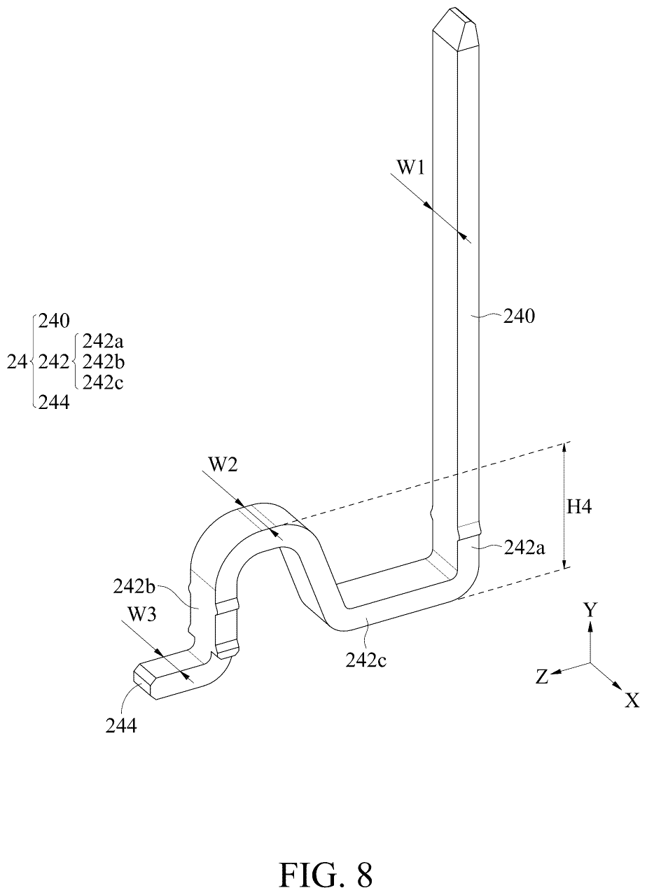

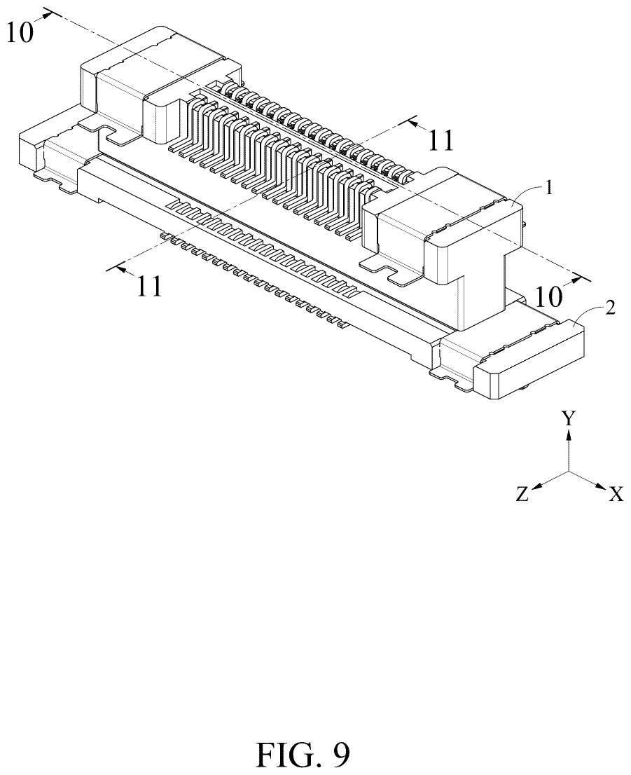

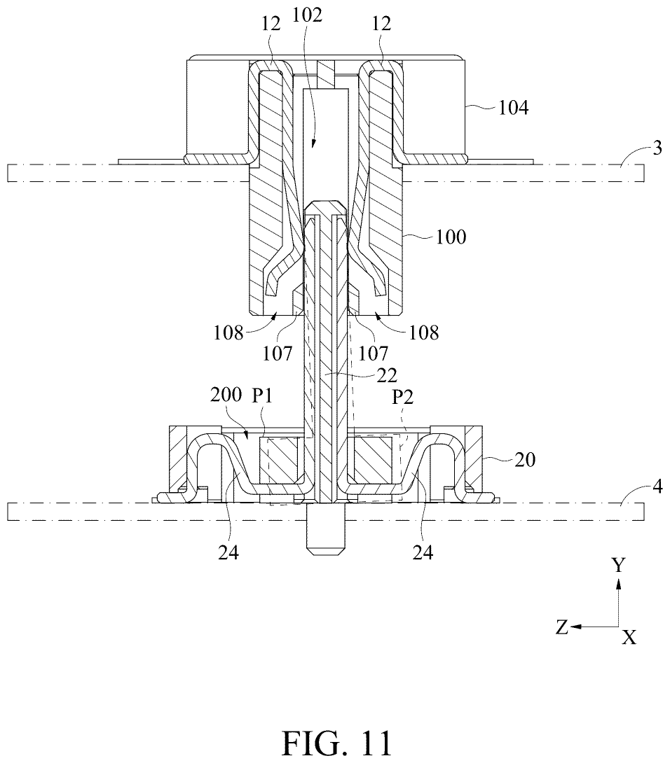

Please refer to FIG. 1, FIG. 2, FIG. 6, FIG. 7, FIG. 8, FIG. 9, and FIG. 11. FIG. 1 illustrates an exploded view of a floating-type board-to-board connector assembly and circuit boards 3, 4 according to some embodiments of the instant disclosure, where the floating-type board-to-board connector assembly is assembled on the circuit boards 3, 4; FIG. 2 illustrates an exploded view of a floating-type board-to-board connector assembly according to some embodiments of the instant disclosure; FIG. 6 illustrates a perspective view of a receptacle terminal 12 according to some embodiments of the instant disclosure; FIG. 7 illustrates an exploded view of a plug connector 2 according to some embodiments of the instant disclosure; FIG. 8 illustrates a perspective view of a plug terminal 24 according to some embodiments of the instant disclosure; FIG. 9 illustrates a perspective view of a floating-type board-to-board connector assembly according to some embodiments of the instant disclosure, where the circuit boards 3, 4 are not shown; and FIG. 11 illustrates a cross-sectional view (1) along the line 11-11 shown in FIG. 9, where the circuit boards 3, 4 are illustrated with one dot-dashed lines, the floating base illustrated with solid lines indicates that the floating base 22 is at the original position P1, and the floating base illustrated with dashed lines indicates that floating base 22 is at the wobbling position P2.

Please refer to FIG. 1. A floating-type board-to-board connector assembly comprises a receptacle connector 1 and a plug connector 2, and the receptacle connector 1 is adapted to be inserted into an insertion hole 30 of a circuit board 3, so that the receptacle connector 1 is formed as an embedded configuration with respect to the circuit board 3. The receptacle connector 1 is adapted to be electrically connected to the plug connector 2, and the plug connector 2 is adapted to be assembled on a surface of a circuit board 4.

Please refer to FIG. 1, FIG. 2, and FIG. 11. The receptacle connector 1 mainly comprises a base portion 10 and a plurality of receptacle terminals 12. The base portion 10 comprises an insertion portion 100, and the insertion portion 100 is inserted into the circuit board 3; that is, in some embodiments, the insertion portion 100 penetrates the circuit board 3 from the surface 31 of the circuit board 3 to the surface 32 of the circuit board 3 (as shown in FIG. 11). A mating space 102 of the insertion portion 100 is a space of a mating opening 112 of the insertion portion 100 extending toward a top surface of the base portion 10 (as shown in FIG. 2), and the mating space 102 is adapted to be inserted by a tongue portion 220 of a floating base 22 of the plug connector 2. Moreover, the receptacle terminals 12 are held in the base portion 10, and the receptacle terminals 12 are adapted to be electrically connected plug terminals 24 of the plug connector 2 in the mating space 102. Please also refer to FIG. 6 and FIG. 11. Each of the receptacle terminals 12 comprises a flexible contact portion 120, an extension portion 122, and a soldering portion 124. The flexible contact portion 120 is in the mating space 102 and adapted to contact a flat contact portion 240 of the plug terminal 24. The flexible contact portion 122 extends from one of two ends of the extension portion 122 toward a lower opening 108 of the base portion 10 (as shown in FIG. 11), and the soldering portion 124 extends from the other end of the extension portion 122 and protrudes from the outer side surface 110 of the base portion 10 (as shown in FIG. 2).

Moreover, as shown in FIG. 2 and FIG. 7, the plug connector 2 comprises a fixed base 20, a floating base 22, and a plurality of plug terminals 24. The fixed base 20 has a through groove 21 to form an operation space 200. The floating base 22 is in the operation space 200 and a tongue portion 220 extends from the floating base 22. Two ends of each of the plug terminals 24 are connected to the fixed base 20 and the floating base 22, respectively. That is, in some embodiments, the fixed base 20 and the floating base 22 are indirectly connected to each other through the plug terminals 24, and the fixed base 20 and the floating base 22 do not contact each other.

Specifically, in some embodiments, as shown in FIG. 1 and FIG. 8, each of the plug terminals 24 comprises a flat contact portion 240, a flexible connection portion 242, and a soldering portion 244. The flexible connection portion 242 is in the operation space 200 of the fixed base 20, the flat contact portion 240 extends from one of two ends of the flexible connection portion 242 toward a surface of the tongue portion 220, and the soldering portion 244 extends from the other end of the flexible connection portion 242 and is exposed from the fixed base 20. In other words, in some embodiments, the flat contact portion 240 is at a surface of the floating base 22, the flexible connection portion 242 is in the through groove 21 (the operation space 200) of the fixed base 20, the soldering portion 244 is exposed from the fixed base 20, and two ends of the flexible connection portion 242 extend toward the flat contact portion 240 and the soldering portion 244, respectively. As shown in FIG. 11, the floating base 22 is connected to the fixed base 20 through the flexible connection portions 242 of the plug terminals 24, so that the flat contact portions 240 can be kept contacting the flexible contact portions 120 of the receptacle terminals 12. Specifically, in some embodiments, when the plug connector 2 is mated with the receptacle connector 1, the flexible contact portions 120 of the receptacle terminals 12 are in the mating space 102 and contact the flat contact portions 240 of the plug terminals 24, where for each of the plug terminals 24 and a corresponding one of the receptacle terminals 12, the configuration of the flat contact portion 240 of the plug terminal 24 defines a contact range of the flat contact portion 240 to be moved vertically with respect to the flexible contact portion 120 of the receptacle terminal 12.

Accordingly, the receptacle connector 1 and the plug connector 2 are mated with each other in a floating manner, and the floating base 22 of the plug connector 2 is in the operation space 200 of the fixed base 20. Moreover, the floating base 22 of the plug connector 2 has movement tolerances along multiple axes in the operation space 200 of the fixed base 20, so that the connector assembly can absorb the external force suffered during shaking. Moreover, such configuration ensures the stability of the floating base 22 and allows the electrical connection between the receptacle connector 1 and the plug connector 2 to be maintained properly.

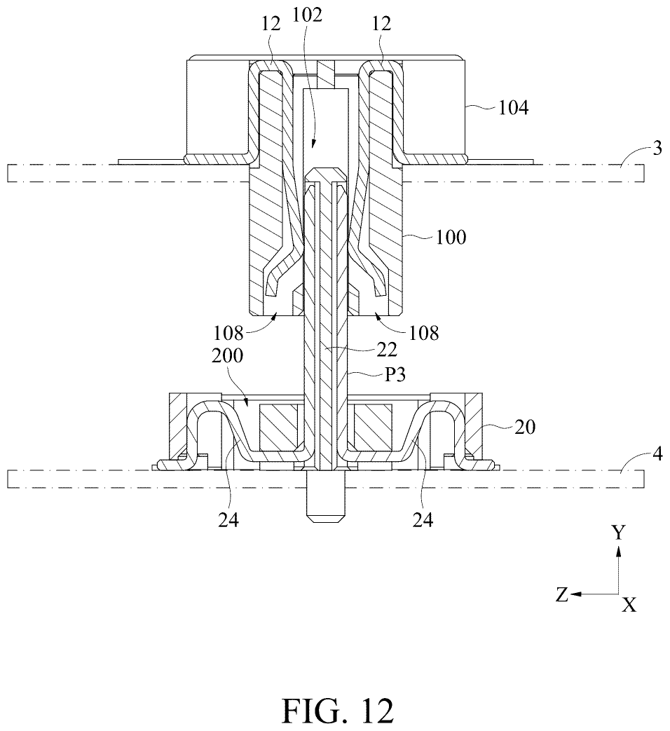

Please refer to FIG. 9, FIG. 11, and FIG. 12. FIG. 12 illustrates a cross-sectional view (2) along the line 11-11 shown in FIG. 9; where the floating base 22 is at the shaking position P3, and the circuit boards 3, 4 are illustrated with one dot-dashed lines. In some embodiments, the floating base 22 has an original position P1 on at least one axis, and the flexible connection portion 242 of the plug terminal 24 provides a resilient force to allow the floating base 22 to be retained at the original position P1. For example, as shown in FIG. 11, when the circuit board 4 or the floating base 22 is applied with an external force and thus moved along the Z axis direction, the floating base 22 is correspondingly moved from the original position P1 toward the wobbling portion P2; that is, according to the viewing perspective of FIG. 11, the floating base 22 is moved toward the right side of the fixed base 20 (the operation space 200) and moved away from the left side of the fixed base 20 (the operation space 200). Then, the resilient force of the flexible connection portion 242 of the plug terminal 24 allows the floating base 22 to be moved from the wobbling position P2 toward the original position P1, so that the floating base 22 can be retained at the original position P1. According to another embodiment, as shown in FIG. 11 and FIG. 12, when the circuit board 4 or the floating base 22 is applied with an external force and thus moved along the Y axis, the floating base 22 is correspondingly moved from the original position P1 (as shown in FIG. 11) toward the shaking portion P3 (as shown in FIG. 12); that is, the floating base 22 is moved close to the receptacle connector 1. Then, the resilient force of the flexible connection portion 242 of the plug terminal 24 allows the floating base 22 to be moved from the shaking position P3 toward the original position P1, so that the floating base 22 can be retained at the original position P1.

Accordingly, the floating base 22 at least has the movement tolerances along the Z axis (the horizontal axis) and the Y axis (the vertical axis) in the operation space 200. Therefore, the stability of the floating base 22 can be maintained, and the risk of detachment or breaking of the floating-type board-to-board connector assembly can be reduced. Moreover, upon wobbling or shaking, the flat contact portions 240 of the plug terminals 24 and the flexible contact portions 120 of the receptacle terminals 12 can be kept contacting each other, thereby allowing the electrical connection between the plug terminals 24 and the receptacle terminals 12 to be maintained properly.

In the following paragraphs, some embodiments are provided to describe detail structures of the receptacle connector 1 and the plug connector 2.

Please refer to FIG. 2 and FIG. 11. In some embodiments, the receptacle connector 1 further comprises a receptacle pressing plate 14, and the base portion 10 further comprises an abutting portion 104. The abutting portion 104 abuts against the surface 31 of the circuit board 3 (as shown in FIG. 11), the receptacle pressing plate 14 is arranged at the abutting portion 104, and the receptacle pressing plate 14 has a soldering leg 140. The soldering leg 140, the soldering portion 124 of the receptacle terminal 12, and a bottom surface 114 of the abutting portion 104 are at a same horizontal plane and contact the surface 31 of the circuit board 3. In other words, in some embodiments, the height positions of the soldering leg 140, the soldering portion 124 of the receptacle terminal 12, and the bottom surface 114 of the abutting portion 104 with respect to the outer side surface 110 of the base portion 10 are identical, where the height position of the outer side surface 110 is the vertical distance between the outer side surface 110 and the bottom surface 111 of the base portion 10. In some embodiments, the soldering leg 140 of the receptacle pressing plate 14 and the soldering portion 124 of the receptacle terminal 12 are at a middle horizontal position of the receptacle connector 1 (the base portion 10); that is, in some embodiments, the height position of the soldering leg 140 with respect to the outer side surface 110 of the base portion 10 (that is, a thickness of the abutting portion 104) is substantially equal to a vertical distance between the bottom surface 114 of the abutting portion 104 and the bottom surface 111 of the base portion 10 (the insertion portion 100).

Please refer to FIG. 1. When the receptacle connector 1 is inserted into the insertion hole 30 of the circuit board 30, the insertion portion 100 and the abutting portion 104 are at two opposite sides of the circuit board 3, and the abutting portion 104 protrudes from the outer side surface 110 of the base portion 10; from the perspective view of FIG. 1 along the X axis direction, a width of the abutting portion 104 is greater than a width of the insertion hole 30 or greater than a width of the insertion portion 100. In some embodiments, the cross section of the abutting portion 104 and the cross section of the insertion portion 100 are T-shaped. Moreover, because the receptacle terminals 12 are provided for electrical connection and may be detached from the plug connector 2 or even broken upon the receptacle terminals 12 are applied with an external force, the receptacle terminals 12 are devoid of the structural fixation function. Therefore, the receptacle pressing plates 14 can enhance the structural strength of the insertion of the receptacle connector 1 (the base portion 10) on the circuit board 3.

Accordingly, the height position of the soldering portion 124 of the receptacle terminal 12 with respect to the outer side surface 110 of the base portion 10 can correspond to the height position of the receptacle connector 1 in an embedded configuration with respect to the circuit board 3. When the receptacle connector 1 is inserted into the insertion hole 30 of the circuit board 3, the soldering leg 140 of the receptacle pressing plate 14 and the soldering portions 124 of the receptacle terminals 12 are on the surface of the circuit board 3, and such embedded configuration allows the receptacle connector 1 to be soldered conveniently. Moreover, as compared with a board-in receptacle connector (which indicates that the bottom surface of the receptacle connector 1 is soldered on the surface of the circuit board 3), with the embedded-type receptacle connector 1, the distance between the circuit board 3 to which the receptacle connector 1 is embedded and the circuit board 4 on which the plug connector 2 is assembled can be reduced. Moreover, in accordance with the installation space restriction of an electronic device to be connected to the receptacle connector 1, with the receptacle connector 1, the height position of the soldering portion 124 and the soldering leg 140 with respect to the outer side surface 110 of the base portion or the thickness of the abutting portion 104 can be adjusted to increase the success rate for the installation.

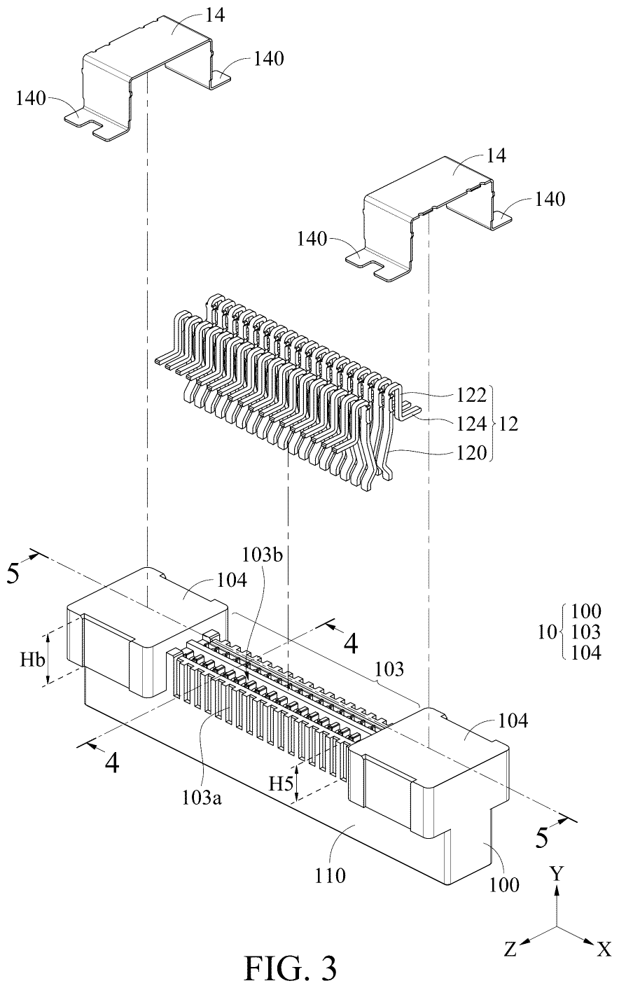

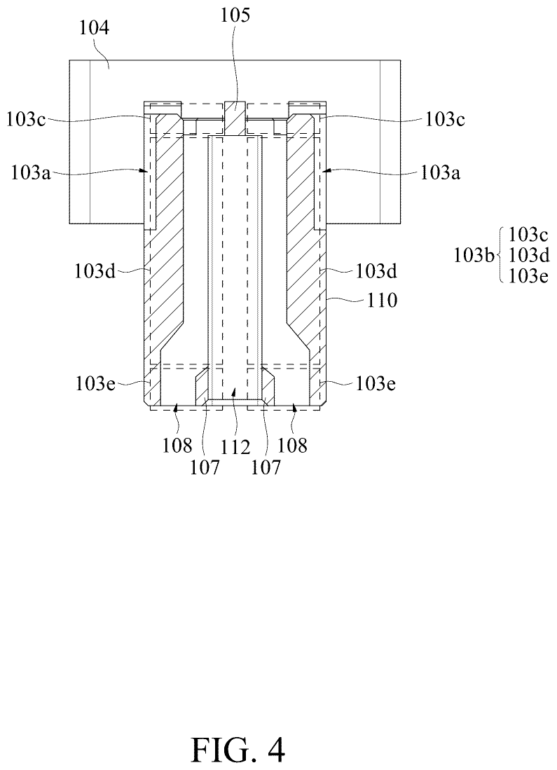

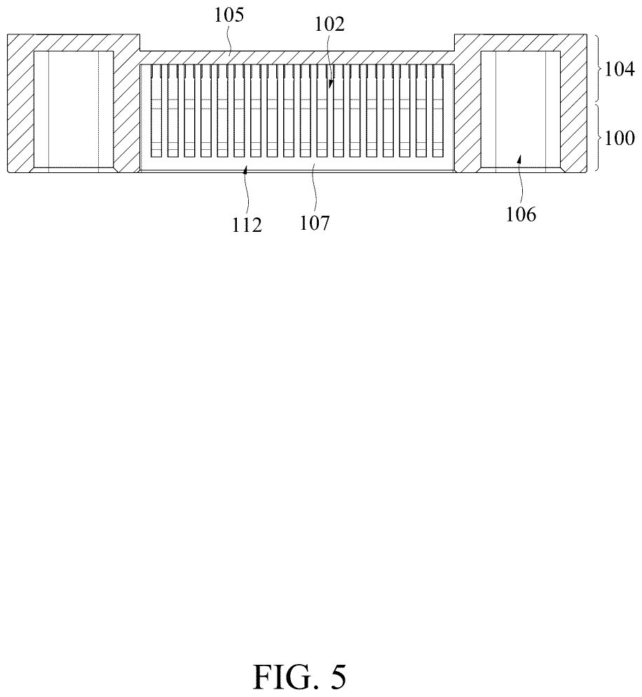

Please refer to FIG. 3, FIG. 4, and FIG. 5. FIG. 3 illustrates an exploded view of a receptacle connector 1 according to some embodiments of the instant disclosure. FIG. 4 illustrates a cross-sectional view along the line 4-4 shown in FIG. 3. FIG. 5 illustrates a cross-sectional view along the line 5-5 shown in FIG. 3.

Please refer to FIG. 2, FIG. 3, and FIG. 5. In some embodiments, the base portion 10 of the receptacle connector 1 comprises two abutting portions 104, and the insertion portion 100 of the receptacle connector 1 has a mating opening 112 and two guiding post holes 106. The mating opening 112 is between the guiding post holes 106, and a center line of the mating opening 112 and center lines of the guiding post holes 106 are aligned with a central axial line L1 of the bottom surface 111 of the insertion portion 100 (as shown in FIG. 2). Each of the guiding post holes 106 extends from the bottom surface 111 of the base portion 10 (the insertion portion 100) toward the top surface of the base portion 10. As shown in FIG. 3 and FIG. 4, in some embodiments, the base portion 10 further comprises a terminal groove portion 103 and a plurality of terminal channels 103b, the terminal groove portion 103 is between the two abutting portions 104, and the terminal groove portion 103 has a plurality of terminal grooves 103a. The terminal grooves 103a are arranged at the outer side surface 110 of the base portion 10, and a length H5 of the terminal groove 103a is less than or equal to a thickness Hb of the abutting portion 104. Moreover, the terminal channel 103b extends from the top surface of the base portion 10 (the terminal groove portion 103) toward the bottom surface 111 of the base portion 10 (the insertion portion 100), and each of the terminal channels 103b corresponds to a corresponding one of the terminal grooves 103a. Specifically, take FIG. 4 as an example, the terminal channel 103b has an upper opening portion 103c, a mating portion 103d, and a lower opening portion 103e. A top separation wall 105 of the base portion 10 separates the upper opening portions 103c of the two opposite terminal channels 103b, the two opposite mating portions 103d are in communication with each other and have the mating opening 112 to form the mating space 102 (as shown in FIG. 2). The lower opening portion 103e is in communication with the mating portion 103d, and the lower opening portion 103e has a lower opening 108. A bottom separation wall 107 of the base portion 10 separates the lower opening 108 from the mating opening 112. As shown in FIG. 2, the lower openings 108 on the bottom surface 111 of the insertion portion 100 are symmetrically arranged at two sides of the mating opening 112 by taking the central axial line L1 as the symmetrical axis.

Please refer to FIG. 3, FIG. 4, and FIG. 6. In the following paragraphs, some embodiments are provided to describe the detail structures showing that the receptacle terminal 12 is in the corresponding terminal groove 103a and the corresponding terminal channel 103b. The soldering portion 124 of the receptacle terminal 12 protrudes from the terminal groove 103a, and the extension portion 122 of the receptacle terminal 12 is in the terminal groove 103a and the terminal channel 103b. The extension portion 122 has an outer side portion 122a, a top portion 122b, and an inner side portion 122c. The top portion 122b is at the top surface of the base portion 10 (the terminal groove portion 103), the outer side portion 122a is at the terminal groove 103a, the inner side portion 122c is in the terminal channel 103b, and the inner side portion 122c is engaged with the mating portion 103d of the terminal channel 103b. Moreover, the flexible contact portion 120 of the receptacle terminal 12 has a protrusion 120a and a free end 120b. The protrusion 120a is at the mating portion 103d of the terminal channel 103b, and the free end 120b is at the lower opening portion 103e of the terminal channel 103b.

Furthermore, as shown in FIG. 6, a vertical distance H1 between the top portion 122b of the extension portion 122 and the soldering portion 124 (that is, a length of the outer side portion 122a of the extension portion 122 or the length H5 of the terminal groove 103a shown in FIG. 3) is less than a vertical distance H3 between the top portion 122b of the extension portion 122 and the free end 120b of the flexible contact portion 120, and the vertical distance H3 between the top portion 122b of the extension portion 122 and the free end 120b of the flexible contact portion 120 is substantially equal to a vertical distance between a top surface of the terminal groove portion 103 and the bottom surface 111 of the insertion portion 100 (that is, a depth of the terminal channel 103b). Moreover, the vertical distance H1 between the top portion 122b of the extension portion 122 and the soldering portion 124 is less than a vertical distance H2 between the top portion 122b of the extension portion 122 and the protrusion 120a of the flexible contact portion 120. Therefore, the height difference between the leg (the soldering portion 124) of the receptacle terminal 12 and the electrical contact (the protrusion 120a) of the receptacle terminal 12 can be adjusted to correspond to the embedded configuration of the receptacle connector 1 with respect to the circuit board 3.

Please refer to FIG. 5 and FIG. 11. In some embodiments, the free end 120b of the flexible contact portion 120 selectively abuts against the bottom separation wall 107 or moves away from the bottom separation wall 107. For example, as shown in FIG. 11, when the receptacle connector 1 is mating with the plug connector 2, the floating base 22 of the plug connector 2 expands the protrusions 120a of two opposite flexible contact portions 120, so that the free end 120b is moved away from the bottom separation wall 107. When the receptacle connector 1 is not mated with the plug connector 2 yet, the free end 120b abuts against the bottom separation wall 107.

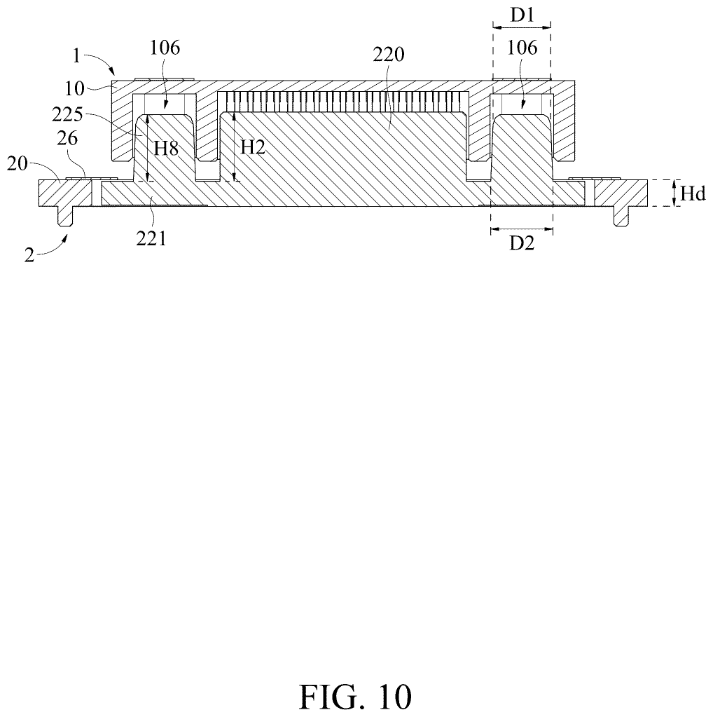

On the other hand, please refer to FIG. 2 and FIG. 10. FIG. 10 illustrates a cross-sectional view along the line 10-10 shown in FIG. 9. In some embodiments, the floating base 22 of the plug connector 2 comprises a base plate 221, a tongue portion 220, and two guiding posts 225. The tongue portion 220 and the guiding posts 225 protrude from the base plate 221, the tongue portion 220 is between the two guiding posts 225, and a center line of the tongue portion 220 and center lines of the guiding posts 225 are aligned with a central axial line L2 of the base plate 221 (as shown in FIG. 2). The guiding post 225 is adapted to be correspondingly mated with the guiding post hole 106 of the receptacle connector 1, and the tongue portion 220 is adapted to be correspondingly mated with the mating opening 112 (the mating space 102) of the receptacle connector 1.

Accordingly, the receptacle connector 1 and the plug connector 2 are mated with each other in a floating manner. During the mating, the guiding and positioning function provided by the guiding post 225 can help the user mating the tongue portion 220 with the mating opening 112 of the receptacle connector 1 correctly. Therefore, the floating-type board-to-board connector assembly provides the blind mating function for the users. Hence, the problems caused by improper mating which thus leads the damage of component or function of the connectors can be reduced.

Please refer to FIG. 10. In some embodiments, a height H8 of the guiding post 225 of the receptacle connector 2 is greater than or equal to a height H22 of the tongue portion 220, a width D2 of a bottom of the guiding post 225 is greater than a width D1 of a top of the guiding post 225, and a shape of the cross-section of the base of the guiding post 225 corresponds to a shape of an opening of the guiding post hole 106. In some embodiments, the height H8 of the guiding post 225 is not less than the height H22 of the tongue portion 220, and the guiding post 225 is a cylinder or cone having a narrower top and a wider bottom. The number of the guiding post 225 is at least one. In one embodiment, the number of the guiding posts 225 is an even number, and the guiding posts 225 are symmetrically arranged at two sides of the tongue portion 220. Accordingly, the guiding and positioning performance of the guiding post 225 can be enhanced.

Moreover, as shown in FIG. 7 and FIG. 10, in some embodiments, the plug connector 2 further comprises two plug pressing plates 26. The plug pressing plates 26 cover the fixed base 20 and the base plate 221 of the floating base 22. The plug pressing plates 26 are adapted to fix the fixed base 20 on the circuit board 4. Moreover, the plug pressing plates 26 also prevent the floating base 22 from overly moving away from the through groove 21 of the fixed base 20 when the floating base 22 is applied with an external force, so that the floating base 22 can be retained at a horizontal position corresponding to a horizontal position of the fixed base 20. However, the plug pressing plates 26 do not interfere with the horizontal movement of the floating base 22.

Please refer to FIG. 7 and FIG. 8. In the following paragraphs, some embodiments are provided to describe the detail structures showing that the plug terminal 24 is between the fixed base 20 and the floating base 22. The tongue portion 220 of the floating base 22 has a plurality of terminal recesses 224, and the through groove 21 of the fixed base 20 has a plurality of terminal fixation grooves 23. Each of the terminal recesses 224 corresponds to a corresponding one of the terminal fixation grooves 23. Each of the plug terminals 24 is in a corresponding one of the terminal recesses 224 and the corresponding one of the terminal fixation grooves 23. The flat contact portion 240 of the plug terminal 24 is in the terminal recess 224, the flexible connection portion 242 is in the gap between the base plate 221 and the fixed base 20, and the soldering portion 244 extends outwards along the bottom surface of the terminal fixation groove 23 (the fixed base 20).

Specifically, in some embodiments, as shown in FIG. 8, the flexible connection portion 242 of the plug terminal 24 comprises a first engaging portion 242a, a bent portion 242c, and a second engaging portion 242b. The bent portion 242c is between the first engaging portion 242a and the second engaging portion 242b, a flange of the first engaging portion 242a is engaged with the base plate 221 of the floating base 22, the bent portion 242c extends from the first engaging portion 242a toward the bottom surface of the base plate 221 and bends toward the terminal fixation groove 23 (the fixed base 20), and a flange of the second engaging portion 242b is engaged with the terminal fixation groove 23. In some embodiments, a width W3 of the soldering portion 244 of the plug terminal 24 is less than a width W2 of the bent portion 242c, and the width W2 of the bent portion 242c is equal to a width W1 of the flat contact portion 240. A height H4 of the bent portion 242c is less than or equal to a depth Hd of the through groove 21 of the fixed base 20 (as shown in FIG. 10).

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A floating-type board-to-board connector assembly comprising:
a plug connector comprising:
a fixed base having an operation space;
a floating base in the operation space, wherein the floating base comprise a tongue portion; and
a plurality of plug terminals, wherein each of the plug terminals comprises a flat contact portion, a flexible connection portion, and a soldering portion; for each of the plug terminals, the flexible connection portion is in the operation space of the fixed base, the flat contact portion extends from one of two ends of the flexible connection portion toward a surface of the tongue portion, and the soldering portion extends from the other end of the flexible connection portion and is exposed from the fixed base; and
a receptacle connector comprising:
a base portion comprising an insertion portion, wherein the insertion portion has a mating space adapted to be inserted by the tongue portion; and
a plurality of receptacle terminals held in the base portion, wherein each of the receptacle terminals comprises a flexible contact portion, an extension portion, and a soldering portion; for each of the receptacle terminals, the flexible contact portion is in the mating space and adapted to contact the flat contact portion, the extension portion is at a top surface of the base portion and bends along an outer side surface of the base portion, the flexible contact portion extends from one of two ends of the extension portion toward a lower opening of the base portion, and the soldering portion extends from the other end of the extension portion and protrudes from the outer side surface of the base portion;
wherein the floating base is connected to the fixed base through the flexible connection portions of the plug terminals, so that the flat contact portions of the plug terminals can be kept contacting the flexible contact portions of the receptacle terminals.

2. The floating-type board-to-board connector assembly according to claim 1, wherein the floating base has a first position along at least one axis, and the flexible connection portion of each of the plug terminals is adapted to provide a resilient force to retain the floating base at the first position.

3. The floating-type board-to-board connector assembly according to claim 2, wherein the at least one axis comprises a first axis and a second axis, the floating base is movable along the first axis and has the first position and a second position, when the floating base is moved from the first position toward the second position, the floating base is moved close to the receptacle connector;
the floating base is movable along the second axis and has the first position and a third position, when the floating base is moved from the first position toward the third position, the floating base is moved toward or away from one side of the fixed base.

4. The floating-type board-to-board connector assembly according to claim 1, wherein the fixed base of the plug connector has a through groove, and the through groove forms the operation space; and
the floating base further comprises:
a base plate in the through groove, wherein the flexible connection portion of each of the plug terminals is in a gap between the bae plate and the fixed base; the tongue portion protrudes from the base plate, and a center line of the tongue portion is aligned with a central axial line of the base plate.

5. The floating-type board-to-board connector assembly according to claim 4, wherein for each of the plug terminals, the flat contact portion is in a terminal recess of the tongue portion, the flexible connection portion is engaged with the terminal recess and a terminal fixation groove of the through groove, and the soldering portion extends outwards along a bottom surface of the terminal fixation groove.

6. The floating-type board-to-board connector assembly according to claim 4, wherein the plug connector further comprises two plug pressing plates, and each of the plug pressing plates covers the base plate of the floating base and the fixed base.

7. The floating-type board-to-board connector assembly according to claim 1, wherein the base portion of the receptacle connector further comprises:
two abutting portions protruding from an outer side surface of the base portion; and
two receptacle pressing plates respectively arranged at the two abutting portions, wherein each of the receptacle pressing plates has a soldering leg, and the soldering leg, the soldering portion of each of the receptacle terminals, and a bottom surface of each of the abutting portions are at a same horizontal plane.

8. The floating-type board-to-board connector assembly according to claim 7, wherein the base portion of the receptacle connector further comprises:
a plurality of terminal grooves between the abutting portions, wherein the soldering portion of each of the receptacle terminals protrudes from a corresponding one of the terminal grooves; and
a plurality of terminal channels, wherein each of the terminal channels extends from the top surface of the base portion toward a bottom surface of the base portion, each of the terminal channels corresponds to a corresponding one of the terminal grooves, and the flexible contact portion of each of the receptacle terminals is in a corresponding one of the terminal channels.

9. The floating-type board-to-board connector assembly according to claim 8, wherein each of the terminal channels comprises:
a mating portion, wherein the mating portions of two opposite terminal channels among the terminal channels are in communication with each other and have a mating opening to form the mating space; and
a lower opening portion in communication with the mating portion, wherein the lower opening portion has the lower opening, and the lower opening is at the bottom surface of the base portion and at one side of the mating opening.

10. The floating-type board-to-board connector assembly according to claim 1, wherein for each of the receptacle terminals, a distance between a top portion of the extension portion and the soldering portion is less than a distance between the top portion of the extension portion and a free end of the flexible contact portion.

11. A floating-type plug connector, wherein the floating-type plug connector is adapted to be mated with a receptacle connector, and the floating-type plug connector comprises:
a fixed base having an operation space;
a floating base in the operation space, wherein the floating base comprise a tongue portion; and
a plurality of plug terminals, wherein each of the plug terminals comprises a flat contact portion, a flexible connection portion, and a soldering portion; for each of the plug terminals, the flexible connection portion is in the operation space of the fixed base, the flat contact portion extends from one of two ends of the flexible connection portion toward a surface of the tongue portion, and the soldering portion extends from the other end of the flexible connection portion and is exposed from the fixed base;
wherein the floating base is connected to the fixed base through the flexible connection portions of the plug terminals.

12. The floating-type plug connector according to claim 11, wherein the floating base has a first position along at least one axis, and the flexible connection portion of each of the plug terminals is adapted to provide a resilient force to retain the floating base at the first position.

13. The floating-type plug connector according to claim 12, wherein the at least one axis comprises a first axis and a second axis, the floating base is movable along the first axis and has the first position and a second position, when the floating base is moved from the first position toward the second position, the floating base is moved close to the receptacle connector;
the floating base is movable along the second axis and has the first position and a third position, when the floating base is moved from the first position toward the third position, the floating base is moved toward or away from one side of the fixed base.

14. The floating-type plug connector according to claim 11, wherein the fixed base has a through groove, and the through groove forms the operation space; and
the floating base further comprises:
a base plate in the through groove, wherein the flexible connection portion of each of the plug terminals is in a gap between the bae plate and the fixed base; the tongue portion protrudes from the base plate, and a center line of the tongue portion is aligned with a central axial line of the base plate.

15. The floating-type plug connector according to claim 14, wherein for each of the plug terminals, the flat contact portion is in a terminal recess of the tongue portion, the flexible connection portion is engaged with the terminal recess and a terminal fixation groove of the through groove, and the soldering portion extends outwards along a bottom surface of the terminal fixation groove.

16. The floating-type plug connector according to claim 14, wherein the floating-type plug connector further comprises two plug pressing plates, and each of the plug pressing plates covers the base plate of the floating base and the fixed base.

17. The floating-type plug connector according to claim 11, wherein the receptacle connector comprises:
a base portion comprising an insertion portion, wherein the insertion portion has a mating space adapted to be inserted by the tongue portion; and
a plurality of receptacle terminals held in the base portion, wherein each of the receptacle terminals comprises a flexible contact portion, an extension portion, and a soldering portion; for each of the receptacle terminals, the flexible contact portion is in the mating space and adapted to contact the flat contact portion, the extension portion is at a top surface of the base portion and bends along an outer side surface of the base portion, the flexible contact portion extends from one of two ends of the extension portion toward a lower opening of the base portion, and the soldering portion extends from the other end of the extension portion and protrudes from the outer side surface of the base portion; wherein the base portion further comprises:
two abutting portions protruding from an outer side surface of the base portion; and
two receptacle pressing plates respectively arranged at the two abutting portions, wherein each of the receptacle pressing plates has a soldering leg, and the soldering leg, the soldering portion of each of the receptacle terminals, and a bottom surface of each of the abutting portions are at a same horizontal plane.

18. The floating-type plug connector according to claim 17, wherein the base portion of the receptacle connector further comprises:
a plurality of terminal grooves between the abutting portions, wherein the soldering portion of each of the receptacle terminals protrudes from a corresponding one of the terminal grooves; and
a plurality of terminal channels, wherein each of the terminal channels extends from the top surface of the base portion toward a bottom surface of the base portion, each of the terminal channels corresponds to a corresponding one of the terminal grooves, and the flexible contact portion of each of the receptacle terminals is in a corresponding one of the terminal channels.

19. The floating-type plug connector according to claim 18, wherein each of the terminal channels comprises:
a mating portion, wherein the mating portions of two opposite terminal channels among the terminal channels are in communication with each other and have a mating opening to form the mating space; and
a lower opening portion in communication with the mating portion, wherein the lower opening portion has the lower opening, and the lower opening is at the bottom surface of the base portion and at one side of the mating opening.

20. The floating-type plug connector according to claim 19, wherein for each of the receptacle terminals, a distance between a top portion of the extension portion and the soldering portion is less than a distance between the top portion of the extension portion and a free end of the flexible contact portion.
